(19) United States
(12) Patent Application Publication
(10) Pub. No.: US 2025/0099884 A1
(43) Pub. Date: Mar. 27, 2025

(54) FILTER SYSTEM WITH BACKFLUSH

(71) Applicant: INDUFIL BV, DUIVEN (NL)

(72) Inventors: Marco Vent, Hessen (DE); Arnd Hartung, DUIVEN (NL)

(21) Appl. No.: 18/727,171

(22) PCT Filed: Jan. 6, 2023
(86) PCT No.: PCT/EP2023/050226

§ 371 Date: Jul. 8, 2024

(30) Foreign Application Priority Data
Jan. 7, 2022 (GB) 2200189.5

(51) Int. Cl. B01D 29/68; B01D 29/15; B01D 46/24; B01D 46/72

(52) U.S. Cl. CPC B01D 29/682; B01D 29/15; B01D 46/24; B01D 46/72; B01D 2201/084

(57) ABSTRACT

Filter systems are provided comprising a filter element and a backflush device configured to provide a backflush fluid flow through the filter element. The filter element can comprise one or more elongate supporting portions for supporting a filtration means; and the backflush device can comprise an elongate outlet configured to provide a backflush fluid flow through the filter element such that the backflush fluid flow intersects the filter element along a line that is non-parallel with the one or more elongate supporting portions, wherein the elongate outlet comprises at least two separate outlets. A backflush device for a filter system is also provided.

The present disclosure relates to filter systems. In particular, the present disclosure relates to a backflush device for filter systems and filter systems comprising a backflush device.

### BACKGROUND

Filter systems are used to separate components of fluid mixtures by passing a fluid to be filtered through a filter medium that permits the passage of the bulk fluid but prevents passage of other components present in the fluid. For example, solid components may be separated from a liquid by filtration, or particulate solids or liquids in the form of aerosols may be separated from a gaseous fluid by filtration.

During filtration, components filtered out from a fluid can deposit on the filter and remain entrained in or on the filter medium. Such deposits can build up over time, and their presence may lead to reduced filter performance, reduced flow or blockage. Filter media can be replaced to restore performance, though regular replacement increases the cost of operation and leads to increased shut-down time during replacement of the filter medium. Deposits may alternatively be removed from filters by backflushing fluid through the filter medium in a direction opposite to the flow of fluid during filtration. In this way, deposits on the filter medium may be removed without requiring removal of the filter. A backflush device may be incorporated into a filter system such that backflush can be carried out as needed without disassembly of the system in order to to reduce system shut-down time.

Backflush may be provided from an outlet of a backflush device that can be moved across the filter surface to provide backflush flow through the filter medium. For example, US 2012/163,480 A1 describes a filter backflush system incorporating a slit shaped opening extending in a straight line parallel to the longitudinal axis of a cylindrical filter body, where the slit is designed to provide a uniform rectangular flow to the filter with increased momentum of backflush fluid.

### SUMMARY OF THE DISCLOSURE

To withstand the pressure of fluid flow against the filter medium (for example during filtration), filter media are typically supported by a support structure arranged to prevent excessive deflection of the filter medium due to the fluid pressure on the surface. To provide support across the filter surface, such support structures typically comprise elongate elements, for example in the form of a square mesh through which fluid can flow with relative ease in comparison to the filter medium itself. However, the Applicant has appreciated that the vertically aligned elongate elements of such a support structure will intermittently align with a flow of backflush fluid that is provided from an elongate slot such as the longitudinal slit described in US 2012/163,480 A1. It has been found that when a backflush flow is provided across the filter surface in such arrangements, intermittent alignment of the vertical slot with vertical elements of the support structure can produce spikes in backflush pressure against the filter medium and the support structure as the filter surface is moved relative to the backflush flow to sweep the flow across the filter surface. These pressure spikes can increase mechanical wear on the filter and its attachments and can cause undesirable vibrations during backflush operation.

It has been surprisingly found that the above problems may be addressed by controlling the angle at which a backflush fluid flow contacts the filter element of a filter system.

Thus, a first aspect provides a filter system comprising a filter element and a backflush device, wherein: the filter element comprises one or more elongate supporting portions for supporting a filtration means; and the backflush device comprises an elongate outlet configured to provide a backflush fluid flow through the filter element such that the backflush fluid flow intersects the filter element along a line that is non-parallel with the one or more elongate supporting portions, wherein the elongate outlet comprises at least two separate outlets.

By providing a filter system in which a backflush fluid flow from the backflush device intersects the filter element along a line that is non-parallel with the one or more elongate supporting portions, pressure spikes in the backflush fluid flow against the filter may be avoided, as the backflush fluid flow does not fully align with the elongate supporting portions. In this way, the pressure of the backflush fluid flow against the filter element is distributed more evenly across the surface of the filter element, the supporting portions and a filtration means that may be supported on the filter element. Such pressure spikes can over time cause wear and damage to the filter element. For example, where a filtration means is attached and sealed around the filter element, pressure spikes focussed on individual portions of the filter may cause wear at attachment points of the filtration means, leading to decreased lifetime of the filter and/or or leakages. The presence of recurring pressure spikes due to intermittent alignment of the backflush fluid flow with successive supporting portions when the filter is moved relative to the backflush flow may also be avoided, reducing undesirable vibrations during backflush operation. In addition, where the backflush fluid flow aligns with elongate supporting portions of the filter element, this may cause a “shadow” with respect to the cleaning function of the backflush flow immediately after the supporting portion, which may be reduced by avoiding alignment of the backflush fluid flow with the elongate supporting portion.

As described above, the filter element comprises one or more elongate supporting portions for supporting a filtration means. Thus, the filter element may comprise a physical support on which a filtration means may be arranged to permit filtration of a fluid through the filtration means. A filter surface of the filter element may be defined as the portion of the filter element surface through which fluid is able to flow so as to be filtered by a filtration means. In some embodiments, the filter element may comprise one or more elongate supporting portions that are integrated with a filtration means. For example, the filter element may comprise a support over which a separate replaceable filtration means may be attached, or the filter element may itself comprise a filtration means that has supporting portions integrated into a replaceable filtration means. Preferably, the filter element comprises a support over which a separate replaceable filtration means may be attached. In some preferred embodiments, the filter element comprises a mesh upon which a filtration means may be supported. Alternatively, the filter element may comprise a mesh that is integrated into a filtration means.

The one or more elongate supporting portions of the filter element may be made from any suitable material, and it will be appreciated that the material may be varied depending on the nature of the fluid being filtered to avoid corrosion or reaction with fluids used in the system. The elongate supporting portions may suitably be made from a substantially rigid material to reduce flexing of the support during filtration. For example, the elongate supporting portions may be made from metal, and may comprise a metal mesh upon which a filtration means may be supported.

A filtration means as referred to herein will be understood to mean any suitable filter medium that provides selective passage of components present in a fluid flow. For example, filtration means may comprise a woven or non-woven fibrous material, a paper-based material, a membrane, or any other suitable filter medium, and may comprise a pleated filter material. In some embodiments, the filtration means comprises an edge-type filter. Preferably, the filtration means is a sheet material that can be arranged across the surface of the filter element on the elongate supporting portions. It will nonetheless be appreciated that the exact form and material of the filtration means may be selected based on its suitability for the particular fluid to be filtered in the system.

The one or more elongate supporting portions of the filter element are generally impervious to fluid flow. However, it will be appreciated that multiple elongate supporting portions may suitably be spaced from each other to allow a flow of the fluid through the filter element and a supported filtration means.

The filter system may be suitably be used with any fluid to be filtered. The fluid to be filtered by the system may suitably be a liquid or gas. For example, the filter system may be suitable for separating solid components from a liquid by filtration and/or for separating particulate solids or liquids in the form of aerosols from a gaseous fluid. In some instances the filter system may suitably separate components of a biphasic liquid mixture such as an emulsion.

As described previously, a flow of backflush fluid may be provided through the filter element and a filter means supported thereon to remove deposits of materials that have been removed from a filtered fluid. The backflush fluid may be any suitable fluid and it will be appreciated that the preferred fluid may be selected based on the requirements of the system. Preferably, the backflush fluid will correspond substantially to the “clean” fluid that has passed through the filter. For example, where an aqueous fluid is filtered, the backflush fluid may be water or an aqueous solution. In some instances, the backflush fluid may comprise at least a portion of the “clean” fluid that has been previously filtered by the system. Preferably, the backflush fluid is a liquid.

The backflush device comprises an elongate outlet configured to provide a backflush fluid flow through the filter element. The elongate outlet suitably provides a backflush fluid flow that intersects the filter element along a line. It will be appreciated that the width of the line at which the backflush fluid flow intersects the filter element will vary based on the dimensions of the elongate outlet and the distance between the elongate outlet and the filter element. The elongate outlet of the backflush device is suitably configured to provide a backflush fluid flow through the filter element such that the backflush fluid flow intersects the filter element along a line that is non-parallel with the one or more elongate supporting portions of the filter element. The angle between the backflush fluid flow intersecting the filter element, or the elongate outlet, and the one or more elongate supporting portions may be selected based on the particular system and the size of the backflush device. In some embodiments, the angle may suitably be at least 2 degrees, for example at least 4 degrees. In some embodiments, the angle may be at least 5 degrees or at least 10 degrees. The angle may also suitably be no more than 45 degrees, for example no more than 30 degrees or no more than 20 degrees. In some embodiments the angle is no more than 10 degrees.

As described previously, the elongate outlet of the above aspect comprises at least two separate outlets. In this way, the elongate outlet may comprise a plurality of separate outlets, which may be arranged adjacent each other along a line on the backflush device to define the elongate outlet and so as to provide an elongate area of contact between the backflush fluid and the filter element. The at least two outlets of the elongate outlet may preferably be arranged along a straight or curved line on the surface of the backflush device to provide the backflush fluid flow along the length of the straight or curved line. By providing an elongate outlet that is separated into at least two separate outlets, this may allow more consistent flow pressure along the length of the elongate outlet, while providing a backflush flow through a single elongate outlet may lead to variations in pressure along the length of the outlet.

In preferred embodiments, the backflush device comprises one or more baffles arranged at the periphery of the at least two separate outlets, the baffles configured to direct a flow of backflush fluid within the backflush device towards the at least two separate outlets. In this way, the flow pressure from the at least two outlets may be directed so as to provide a more consistent flow pressure across each of the at least two outlets, to provide more consistent flow pressure along the length of the elongate outlet. For example, the at least two separate outlets may be separated by one or more baffles that extend from an external surface of the backflush device comprising the at least two outlets towards an internal volume of the backflush device. The backflush device may thus comprise a common internal volume for receiving backflush fluid, the at least two outlets providing a path for backflush fluid in the internal volume of the backflush device to flow from the internal volume towards the filter element. The baffles may in some embodiments extend in a plane parallel to the flow of backflush fluid through the at least two outlets and perpendicular to the length of the elongate outlet.

In some preferred embodiments, the backflush device comprises an elongate body configured to receive a flow of backflush fluid, the at least two separate outlets configured to permit a flow of backflush fluid radially from an internal volume of the elongate body through an outward-facing surface of the elongate body, wherein the at least two separate outlets are angularly offset from each other relative to a longitudinal axis of the elongate body (i.e. the axis defined by the longest dimension of the backflush device). Thus, the elongate outlet may, for example, define a helical path along an external surface of the backflush device. Alternatively, the elongate outlet may be substantially straight, and the backflush device arranged relative to the filter element so as to provide an angle between the elongate outlet and one or more elongate supporting portions of the filter element.

The backflush device may be made from any suitable material, and it will be appreciated that the backflush device may be made from a material selected based on the particular system and fluids to be filtered (for example to avoid corrosion). For example, the backflush device may be made from a plastic or a metal. In preferred embodiments, the backflush device is made from a 3D printed material. It is has been found that by using 3D printing the desired geometry of the backflush device may be obtained economically, for example the formation of the at least two outlets through a surface of the backflush device that is shaped to conform to a corresponding filter element surface and that can be shaped so as to provide a small spacing between the elongate outlet and the filter element. Alternatively, the backflush device may be formed by any other suitable method such as by injection moulding or milling.

The filter element may be provided in any suitable shape, and it will be appreciated that the filter element may be substantially flat or may comprise a curved surface. Nonetheless, it will be appreciated that the filter element in the filter system will suitably separate a volume in which a fluid to be filtered is provided from a volume into which the filtered fluid passes so that the fluid to be filtered must pass through the filter surface of the filter element and a filtration means supported thereon. Preferably, the filter element defines an internal volume in which the backflush device is disposed, and the filter system is configured to provide filtration by passing a fluid to be filtered from an external volume surrounding the filter element through at least the portion of a filter surface of the filter element into the internal volume of the filter element. The backflush device may therefore be disposed within the filter element and configured to provide the backflush fluid flow radially outwards through at least the portion of a filter surface of the filter element.

The external volume surrounding the filter element preferably comprises a housing surrounding the filter element and having an inlet for receiving the fluid to be filtered and an outlet for removing backflush fluid from the housing. The housing may further comprise a sediment outlet at the lower periphery of the housing for removing sediment such as particulate matter that settles at the bottom of the housing. The housing may be configured so that fluid to be filtered entering the housing is provided in a circulatory flow around the filter element to reduce the proportion of sediment or particulates that contact the filter element, which may provide for reduced deposits on the filtration means leading to reduced backflush requirements and increased longevity of the filter.

In preferred embodiments, the filter element is a generally cylindrical filter element, and the backflush device is configured to provide a backflush fluid flow from the elongate outlet through at least a portion of the curved surface of the generally cylindrical filter element. The filter element may thus comprise a longitudinal curved cylindrical surface and two substantially circular lateral ends, and may suitably be closed at one of the lateral ends to prevent passage of fluid to be filtered, and open at one end to provide a flow path from the interior volume of the filter element out from the system, for example to provide an outlet for “clean” filtered fluid that has passed radially inward through the filter surface of the filter element and filtration means. The backflush device may preferably be coupled at a central shaft within the generally cylindrical filter element and extend radially from the central shaft towards the curved surface of the filter element. The backflush device may comprise one or more attachment points for coupling the backflush device to the central shaft, which may permit the backflush device to remain stationary while the filter element rotates around its longitudinal axis (i.e. the axis that passes through the centre of each of the circular lateral end faces of the cylinder and is radially surrounded by the curved surface).

Due to ease of manufacture, the support structure of a generally cylindrical filter element is typically in the form of a square mesh with vertically and horizontally aligned support struts, the vertically aligned support struts parallel with the longitudinal axis of the generally cylindrical filter element. Therefore, when the filter element is a generally cylindrical filter element, the elongate outlet may comprise at least two portions of the elongate outlet that are angularly offset from each other relative to the longitudinal axis of the generally cylindrical filter element. In this way, the elongate outlet, and the backflush flow therefrom, is not aligned in parallel with the support struts of the filter element.

Preferably, the filter element and the backflush device are configured to move relative to each other to provide the backflush fluid flow across the filter surface of the filter element. In this way, the backflush device may be able to provide a backflush flow across the entire filter surface in order to remove deposits from the filtration means. In preferred embodiments the system is configured so that the backflush device remains stationary and the filter element moves relative to the backflush device, which avoids the need for complex movable attachments at an inlet of the backflush device that is configured to receive a flow of backflush fluid. Where the filter element comprises a generally cylindrical filter element, the filter element may be configured to rotate about its longitudinal axis to provide the backflush fluid flow around the curved surface of the filter element.

In preferred embodiments, the backflush device is configured to provide a backflush fluid flow spanning a longitudinal length of the filter element (e.g. the longest dimension of the filter element or the filter surface) so that relative movement of the backflush device and filter element can provide the backflush fluid flow across substantially all of a filter surface of the filter element. For example, the backflush device may be configured to provide a backflush fluid along the longitudinal length of the filter surface of a generally cylindrical filter element, such that rotation of the filter element about its axis permits the backflush fluid flow to sweep across the entire filter surface on the curved surface of the filter element.

The backflush device may be configured such that the elongate outlet is disposed a constant distance from the filter element along its length. For example, a surface of the backflush device comprising the elongate outlet may be substantially coplanar with the filter surface of the filter element. Where the filter element is a generally cylindrical filter element, the surface of the backflush device comprising the elongate outlet may therefore conform to the interior of the curved surface of a cylinder. The elongate outlet may then be arranged along a line that is angularly offset relative to the longitudinal axis of the cylinder.

The spacing between the elongate outlet (and therefore the at least two outlets) of the backflush device and the filter element may be any suitable spacing depending on the requirements of the system. Preferably, the spacing between the elongate outlet of the backflush device and the filter element is 15 mm or less, preferably 10 mm or less, for example 5 mm or less. By providing a smaller spacing, backflush fluid pressure loss between the elongate outlet and the filter element may be reduced and a consistent backflush flow to the filter element can be provided more efficiently. The elongate outlet of the backflush device may be disposed a constant distance from the filter element throughout relative movement of these parts, or the spacing may vary during movement. Preferably the elongate outlet of the backflush element is disposed a constant distance from the filter element during relative movement thereof. However, in embodiments where the spacing varies, the spacing may suitably be 15 mm or less, preferably 10 mm or less, for example 5 mm or less throughout the range of movement during backflushing.

As described previously, the filter system is suitably configured such that the fluid to be filtered must in use pass through the filter surface of the filter element (and therefore through a filtration means). Thus, the filter element may be configured to support a filtration means attached and sealed around the periphery of a filter surface of the filter element to cover a filter surface of the filter element. For example, where the filter element comprises a generally cylindrical filter element, a filtration means can be attached and sealed around the upper and lower circumferences of the filter element so that fluid must pass through the filtration means on the curved surface of the filter element.

As will be appreciated, while the filter element comprises one or more elongate supporting portions for supporting a filtration means, a filter system as described herein may be provided without the filtration means itself. A filtration means may then be subsequently fitted to provide the required filtration and may be subsequently replaced as necessary. Thus, the filter system may in some embodiments further comprise a filtration means integrated with or supported on the filter element.

A further aspect provides a filter system comprising a filter element and a backflush device, wherein: the filter element comprises one or more elongate supporting portions for supporting a filtration means; and the backflush device comprises an elongate outlet configured to provide a backflush fluid flow through the filter element such that the backflush fluid flow intersects the filter element along a line that is non-parallel with the one or more elongate supporting portions, wherein the spacing between the elongate outlet of the backflush device and the filter element is 15 mm or less.

As will be appreciated, the features of this aspect may be as defined previously herein. For example, the elongate outlet may comprise at least two separate outlets as described previously, or alternatively may comprise a single outlet.

A further aspect provides a filter system comprising a generally cylindrical filter element and a backflush device, wherein: the backflush device is configured to provide a backflush fluid flow through at least a portion of the curved surface of the filter element; the backflush device comprises an elongate outlet configured to provide the backflush fluid flow through the filter element, the elongate outlet comprising at least two portions of the outlet that are angularly offset from each other relative to the longitudinal axis of the generally cylindrical filter element; and at least one of: (i) the elongate outlet comprises at least two separate outlets; and (ii) the spacing between the elongate outlet of the backflush device and the filter element is 15 mm or less.

As will be appreciated, the features of this aspect may be as defined previously herein. For example, the filter element may comprise one or more elongate supporting portions as defined previously. In particular, as described previously, due to ease of manufacture, the support structure of a generally cylindrical filter element is typically in the form of a square mesh with vertically and horizontally aligned support struts, the vertically aligned support struts parallel with the longitudinal axis of the generally cylindrical filter element. Therefore, by providing an elongate outlet comprising at least two portions of the outlet that are angularly offset from each other relative to the longitudinal axis of the generally cylindrical filter element, parallel alignment of the backflush flow from the elongate outlet and the support struts present in a typical cylindrical filter element may be avoided.

A further aspect provides a filter system comprising a filter element and a backflush device configured to move relative to each other to provide a backflush fluid flow across a surface of the filter element, wherein: the backflush device comprises an elongate outlet configured to provide the backflush fluid flow through the filter element such that the backflush fluid flow intersects the filter element along a line that is non-perpendicular to the direction of relative movement of the backflush device and the filter element; and at least one of: (i) the elongate outlet comprises at least two separate outlets; and (ii) the spacing between the elongate outlet of the backflush device and the filter element is 15 mm or less.

As will be appreciated, the features of this aspect may be as defined previously herein.

A further aspect provides a backflush device for providing a backflush fluid flow to a filter element of a filter system, the backflush device comprising: an elongate body configured to receive a flow of backflush fluid; and an elongate outlet configured to direct a flow of backflush fluid radially from an internal volume of the elongate body through an outward-facing surface of the elongate body; wherein the elongate outlet comprises at least two separate outlets that are angularly offset from each other relative to a longitudinal axis of the elongate body.

Preferably, the outward-facing surface comprising the elongate outlet conforms to the inner curved surface of a cylinder, the at least two separate outlets angularly offset from each other relative to the longitudinal axis of the cylinder. For example, the elongate outlet may follow a helical path on the outward-facing surface.

As will be appreciated, the features of the backflush device may be as defined previously herein. For example, the backflush device may comprise material as defined previously such as a 3D printed material.

A further aspect provides a filter system comprising a filter element a backflush device as defined herein, the backflush device arranged to provide a flow of backflush fluid through the filter element.

A further aspect provides a method for removing contaminants from a filtration means using a filter system or a backflush element as defined previously herein.

A further aspect provides a method for removing contaminants from a filtration means supported on a filter element comprising one or more elongate supporting portions, the method comprising providing a backflush fluid flow through the filter element and filtration means such that the backflush fluid flow intersects the filter element along a line that is non-parallel with the one or more elongate supporting portions, wherein at least one of: (i) the elongate outlet comprises at least two separate outlets; and (ii) the spacing between the elongate outlet of the backflush device and the filter element is 15 mm or less.

The method of this aspect and the features of the filter system may be as defined previously herein.

Aspects of the disclosure may be provided in conjunction with each other, and features of one aspect may be applied to other aspects.

### DETAILED DESCRIPTION OF THE DRAWINGS

Embodiments of the disclosure will now be described, by way of example only, with reference to the accompanying drawings, in which:

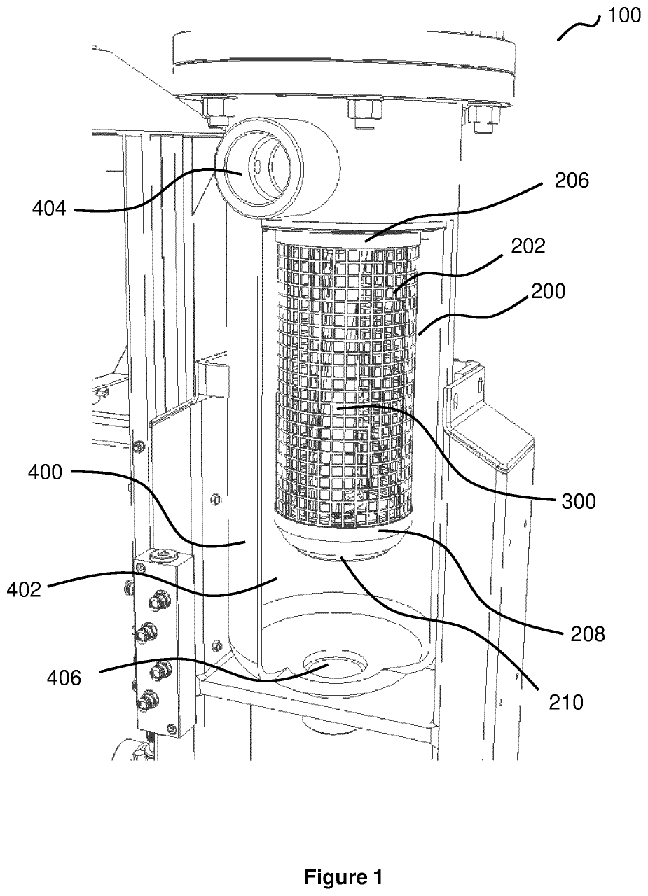

FIG. 1 shows a sectional view of a filtration system comprising a filter element and backflush device;

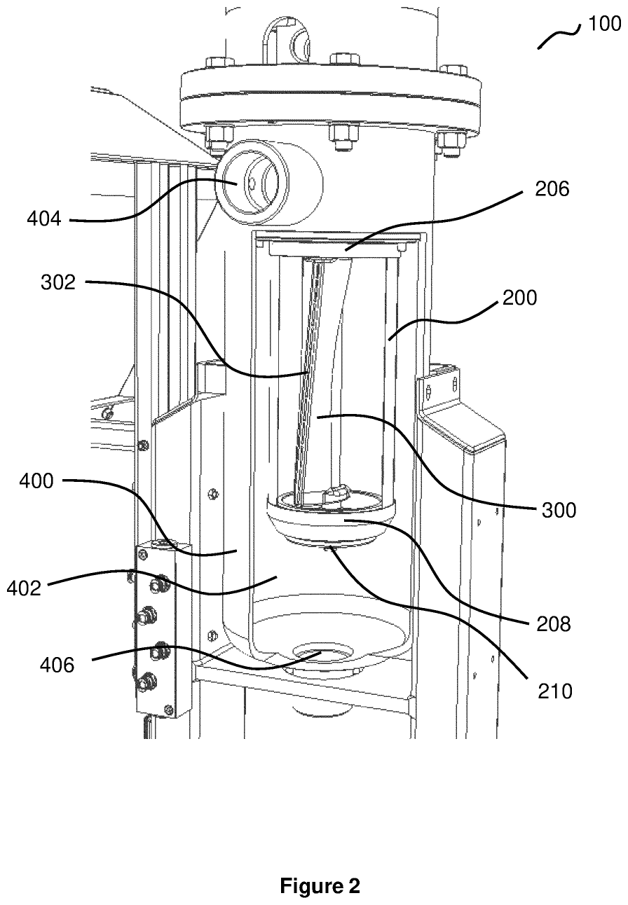

FIG. 2 shows a sectional view of the filtration system and the backflush device;

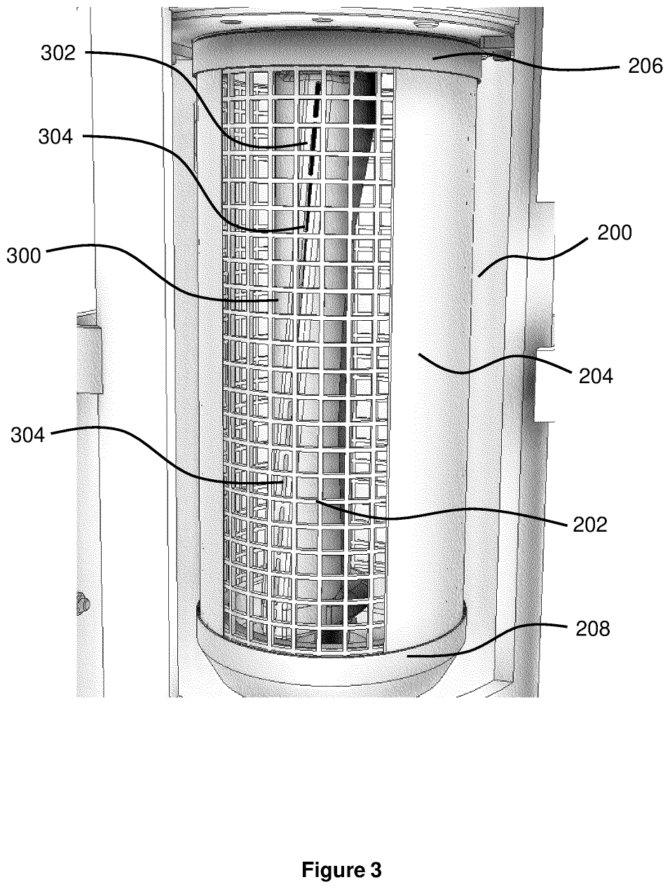

FIG. 3 shows a sectional view of the filter element, a filtration means and the backflush device;

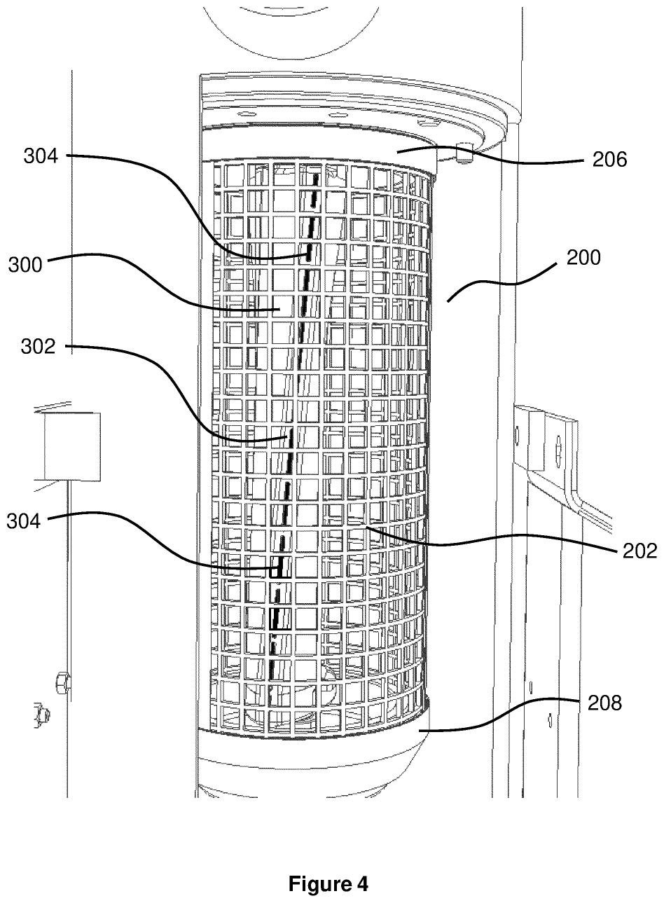

FIG. 4 shows a further sectional view of the filter element and the backflush device;

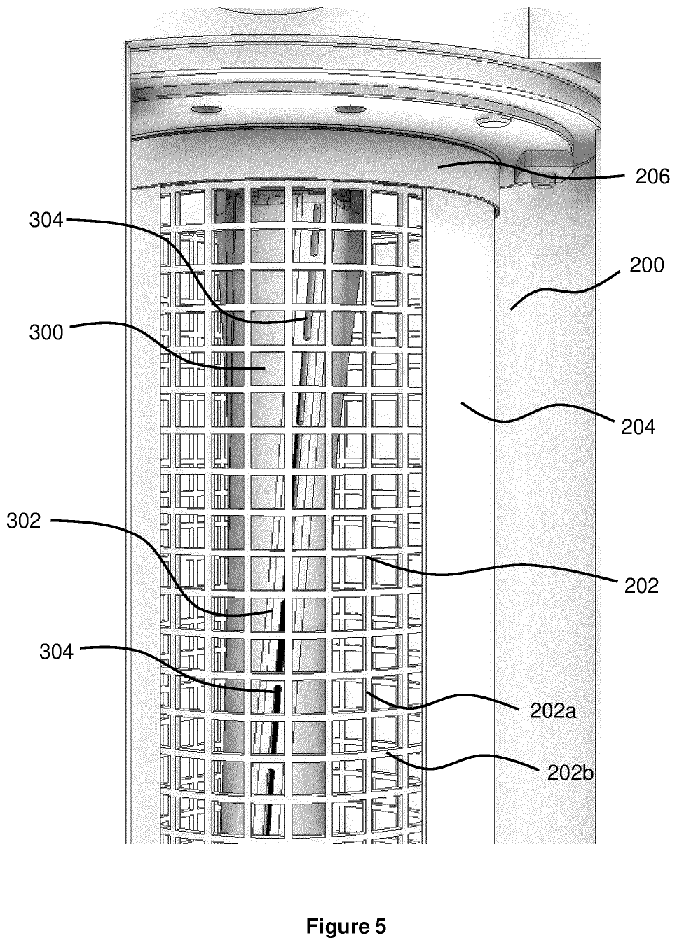

FIG. 5 shows a close-up sectional view of the filter element and the backflush device;

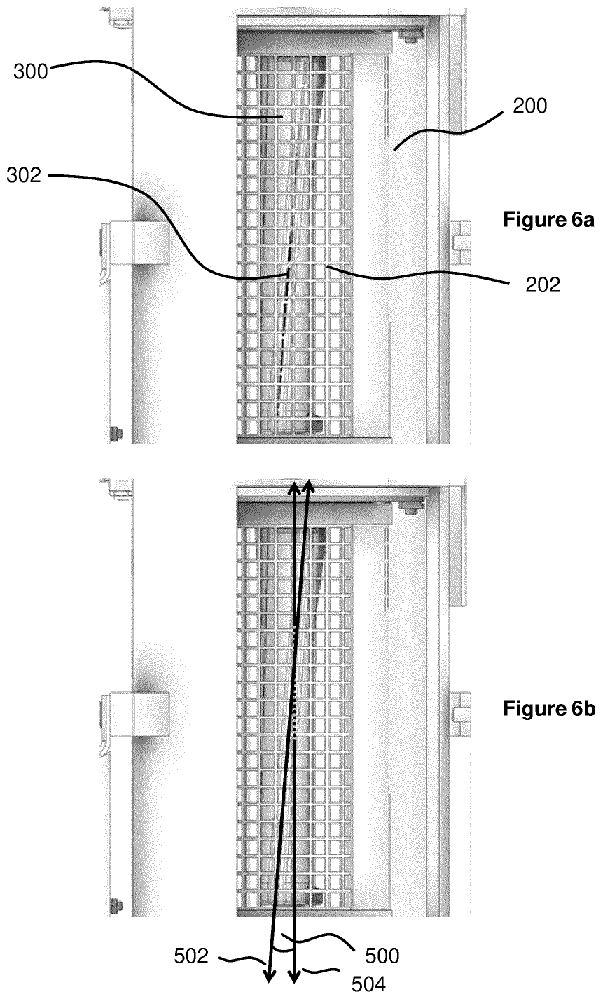

FIGS. 6a and 6b show a sectional view of the filter element and backflush device, illustrating an angular offset of the elongate outlet from the elongate supporting portions;

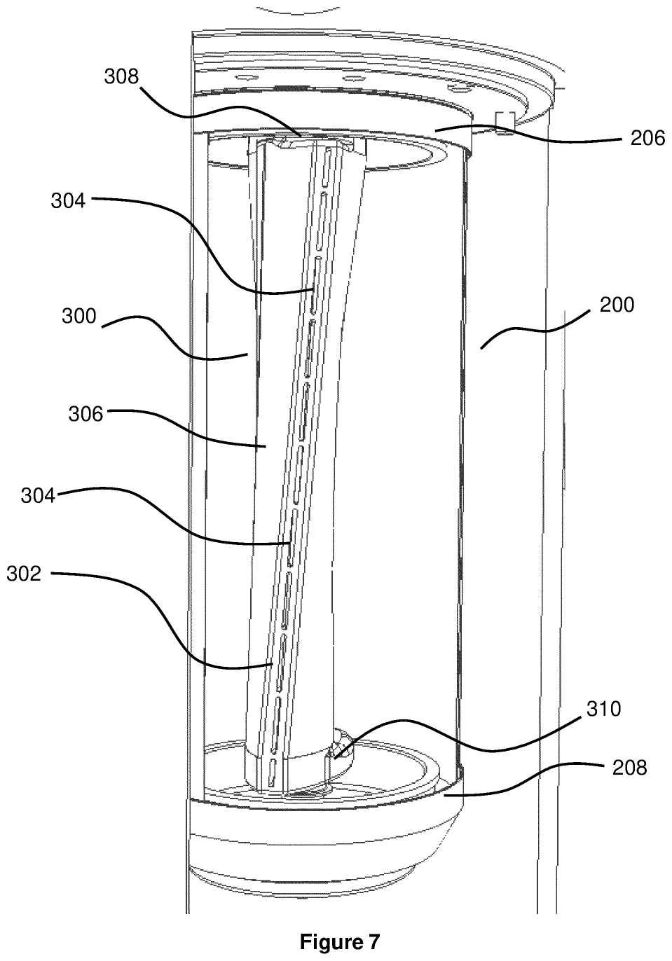

FIG. 7 shows a close-up view of the backflush device within the filter element;

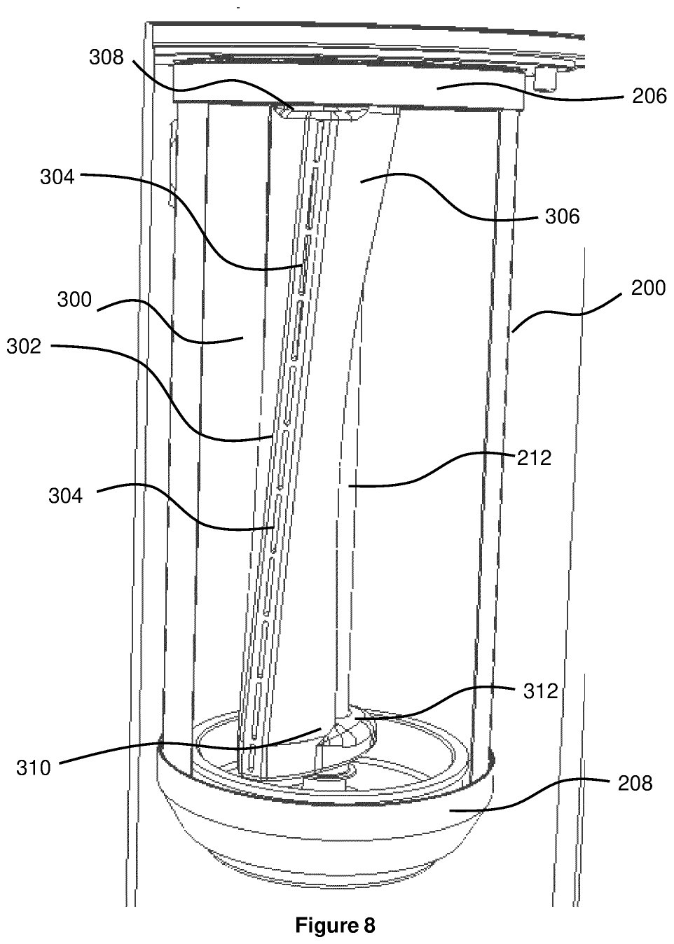

FIG. 8 shows a further close-up view of the backflush device within the filter element;

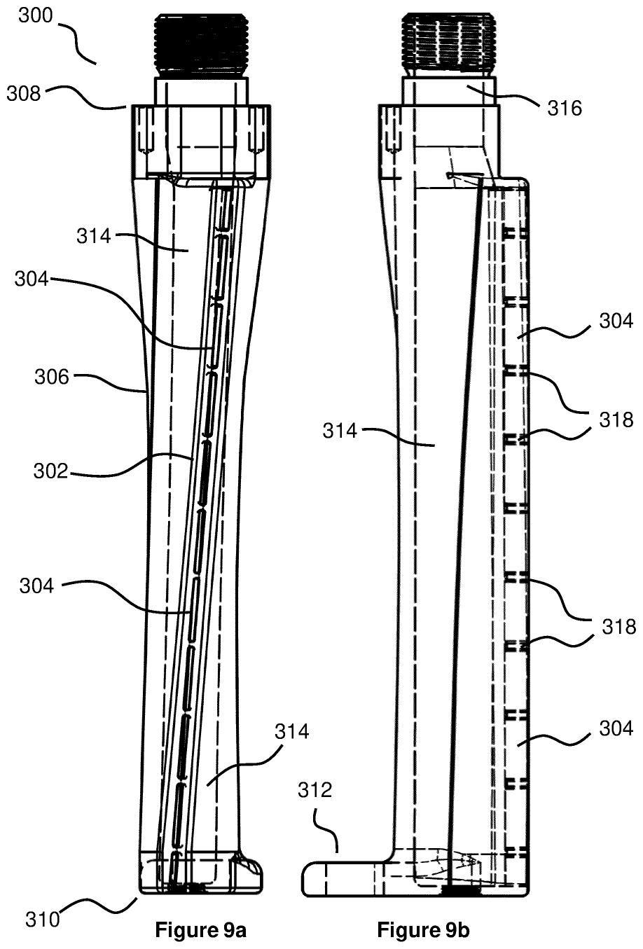

FIGS. 9a and 9b show the backflush device viewed facing the elongate outlet and from a perpendicular side view;

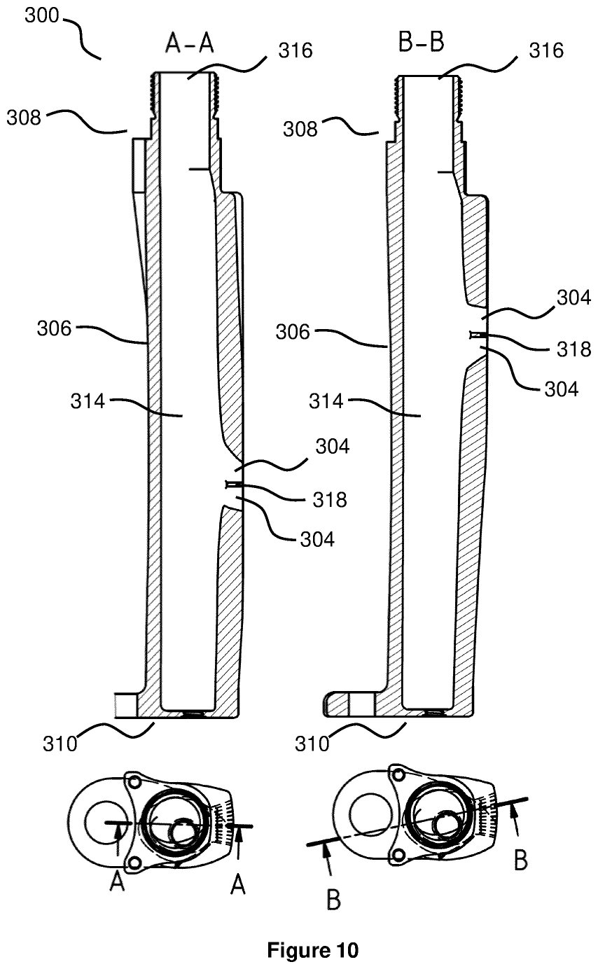

FIG. 10 shows two angularly offset cross-sectional views through the backflush device.

In the figures, like numerals denote like elements.

FIG. 1 shows a sectional view of a filtration system 100 comprising a generally cylindrical filter element 200 and a backflush device 300 disposed within the filter element 200. The filter element 200 comprises a curved surface extending from an upper circumference 206 to a lower circumference 208 of the filter element. The curved surface of the filter element 200 comprises a square mesh 202 defining elongate supporting portions.

The filter element 200 is disposed in an internal volume 402 of a housing 400. The housing comprises an inlet (not shown) for introducing a fluid to be filtered into the internal volume 402. During filtration, the fluid to be filtered in the internal volume 402 of the housing 400 passes radially inward through the curved surface of the filter element 200 such that it must pass through a filtration means supported on the mesh 202 of the filter element 200. Filtered “clean” fluid may then be removed via outlet 404 in fluid communication with the internal volume of the filter element 200. Thus, the filter element 200 is closed at its lower lateral face 210 (bounded by lower circumference 208) and in fluid communication with “clean” fluid outlet 404 at its upper lateral face (bounded by upper circumference 206). The housing 400 also comprises a sediment outlet 406 for removing sediment and particulates that are not deposited in a filtration means on the filter element 200.

During backflush operation, a backflush fluid flow from the backflush device 300 is provided radially outward through the curved surface of the filter element 200 into the internal volume 402 of the housing 400. The filter element 200 is rotated about its longitudinal axis so that the backflush fluid flow from the backflush device 300 is swept around the curved surface of the filter element (and consequently through a filtration means supported on the filter element 200). Although not shown in FIG. 1, the housing further comprises an outlet for removing backflush fluid from the internal volume 402 of the housing 400.

FIG. 2 shows a view of the filter system 100 similar to that of FIG. 1, with the mesh 202 of the filter element 200 not shown. In FIG. 2, backflush device 300 can be seen more clearly, the backflush device 300 having an elongate outlet 302 which is angularly offset relative to the longitudinal axis of the filter element 200. In this way, the elongate outlet 302 may provide a backflush fluid flow that intersects the curved surface of the filter element 200 along a line that is non-parallel with elongate supporting portions of the filter element 200 (i.e. struts of the mesh 202). As can be seen, the elongate outlet 302 is angularly offset from the longitudinal axis of the generally cylindrical filter element such that any two separate portions of the elongate outlet 302 are angularly offset from each other relative to the longitudinal axis of the generally cylindrical filter element. As can also be seen, when the filter element 200 is rotated about its longitudinal axis, the elongate outlet 302 will be non-perpendicular with the direction of relative movement (which will be in a circumferential direction around the curved surface of the filter element 200). In this way, each portion of the elongate outlet 302 along its length will cross vertical struts of the mesh 202 at different times, avoiding pressure spikes that would occur when the backflush fluid flow intermittently aligns with struts of the mesh 202.

FIG. 3 shows a sectional view of the filter element 200, a filtration means 204 and the backflush device 300.

As shown in FIG. 3, a filtration means 204 (partially shown) is attached around the curved surface of the filter element 200, and is supported on the mesh 202. The filtration means 204 is sealed at the upper circumference 206 and the lower circumference 208 of the filter element 200 so as to require fluid to be filtered to pass through the filtration means 204 to enter the internal volume of the filter element 200. FIG. 3 also shows that elongate outlet 302 is composed of a plurality of separate outlets 304, which provide outlets for the backflush fluid to pass from an internal volume 314 of the backflush device 300 radially outward towards the filter element 200.

FIG. 4 shows a further sectional view of the filter element 200 and the backflush device 300. As can be seen, the backflush device comprises a plurality of separate outlets 304 that are arranged to form an elongate outlet 302 that extends from the upper circumference 206 of the filter element 200 to the lower circumference 208 of the filter element 200. As shown in FIG. 4, the plurality of separate outlets 304 are arranged adjacent each other to form an elongate outlet 302 that provides a backflush fluid flow that intersects the filter element 200 along a line that is non-parallel with elongate supporting portions of the filter element 200 (e.g. struts of the mesh 202).

FIG. 5 shows a close-up sectional view of the filter element 200, mesh 202 and the backflush device 300. As can be seen, the curved surface of the filter element 200 comprises a square mesh 202 on which a filtration means 204 is supported. The square mesh 202 comprises perpendicularly aligned vertical elongate struts 202a and horizontal elongate struts 202b, defining elongate supporting portions for the filtration means 204. As shown in FIG. 5, the plurality of separate outlets 304 are arranged adjacent each other to form an elongate outlet 302 that provides a backflush fluid flow that intersects the filter element 200 along a line that is non-parallel with the elongate struts of the mesh 202. As will be appreciated, the elongate outlet defined by the plurality of outlets 304 is non-parallel with the elongate vertical struts 202a that are aligned across the dimension of the filter element 200 across the length of which the elongate outlet 302 extends. That is, while with a supporting mesh, the elongate outlet will always be non-parallel with, for example the horizontal struts 202b, the elongate outlet 302 and the backflush fluid flow therefrom will be non-parallel with the elongate supporting portions that span the same length of the filter element 200 as the elongate outlet 302.

FIGS. 6a and 6b show a sectional view of the filter element 200 and backflush device 300, illustrating the angular offset of the elongate outlet 302 from the elongate supporting portions of the mesh 202. FIGS. 6a and 6b show the relative alignment of the vertical elongate struts 202a and the elongate outlet 302 (and consequently the backflush flow therefrom). FIG. 6b shows the direction of alignment 502 of the elongate outlet 302 and the direction of alignment 504 of the vertical elongate struts 202a, and an angle of offset 500 between the elongate outlet alignment 502 and the vertical strut alignment 504. The angle 500 may for example be about 5 degrees but as will be appreciated this angle may suitably be varied as described previously herein.

FIG. 7 shows a close-up view of the backflush device 300 within the filter element 200. FIG. 7 shows the arrangement of the plurality of separate outlets 304 that are arranged adjacent each other to form an elongate outlet 302 that extends from the upper circumference 206 of the filter element 200 to the lower circumference 208 of the filter element 200. The plurality of separate outlets 304 are configured as slots arranged end to end, however it will be appreciated that any suitable shape for the plurality of outlets 304 may be used. For example, while the separate outlets 304 are shown as themselves being elongate slots, the separate outlets could be non-elongate, for example in the form of circular or other shaped outlets. The separate outlets 304 shown in FIG. 7 are arranged end to end in a line to form an elongate outlet 302 and it will be appreciated that the separate outlets 304 may generally form a line along the elongate outlet 302 but not (where the separate outlets are elongate) meet end to end. For example, the separate outlets 304, where they are themselves individually elongate in shape, may include one or more vertically aligned separate outlets or slots, each of which is angularly offset from the preceding and subsequent outlet along the length of the elongate outlet 302.

As shown in FIG. 7, the backflush device comprises a body 306, which may suitably comprise an internal volume 314 that is configured to receive a supply of backflush fluid from an inlet 316 at the upper end 308 of the backflush device. The internal volume 314 of the body 306 is in fluid communication with the plurality of separate outlets 304 so as to provide the flow of backflush fluid radially outwards from the backflush device. The backflush device body 306 is elongate and extends along a longitudinal axis from an upper end 308 of the backflush device 300 to a lower end 310 of the backflush device 300. The backflush device is suitably dimensioned so that the elongate outlet 302 can provide a flow of backflush fluid spanning the length of the curved surface of the filter element 200 from its upper circumference 206 to its lower circumference 208, so as to allow backflush through substantially all of the filter surface of a filtration means 204 attached over the filter element 200. The backflush device 300 is coupled to the filter system 100 at its upper end 308 to receive a supply of backflush fluid and is coupled at its lower end 310 to a central shaft 212 (see FIG. 8).

FIG. 8 shows a further close-up view of the backflush device 300 within the filter element 200 similar to that shown in FIG. 7. In FIG. 8, it can be seen that the backflush device 300 is coupled to a central shaft 212 within the filter element 200. The central shaft 212 is aligned along the longitudinal axis of the filter element 200, and the backflush device 300 extends radially outwards from the central shaft 212 towards the curved surface of the filter element. The backflush device 300 is coupled to the central shaft 212 by an attachment point 312. While the attachment point 312 is in the form of a portion of the backflush device that surrounds the central shaft 212, other suitable attachment points for coupling to the central shaft 212 may be used. The filter element 200 can be rotated about the central shaft 212 so as to sweep the curved surface of the filter element across the line of intersection between the backflush flow from the elongate outlet 302 and the filter element 200. As described previously, the angle of the elongate outlet 302 precludes parallel alignment of the backflush fluid flow with elongate supporting portions of the filter element 200 (the vertical struts 202a of mesh 202).

While not explicitly shown in FIG. 7 or 8, the backflush device 300 comprises baffles at the periphery of the separate outlets 304 extending radially inward from a portion of the surface separating each of the separate outlets 304. In this way, fluid in the internal volume 314 of the backflush device 300 can be directed to each of the separate outlets 304, which can provide a more consistent flow pressure from each of the outlets 304 and avoid flow within the backflush device 300 favouring certain outlets 304 over others (for example due to the force of gravity biasing flow towards the lower end of the backflush device 300).

FIG. 9 shows views of the backflush device 300 from a face-on view (FIG. 9a) and a perpendicular side view (FIG. 9b). As described in relation to previous Figures, the backflush device 300 comprises a body 306 extending from an upper end 308 to a lower end 310 of the backflush device 300, an elongate outlet 302 comprising a plurality of separate outlets 304, and an attachment point 312 for coupling the backflush device to a central shaft. Internal details of the backflush device 300 are shown in dashed lines in FIGS. 9a and 9b. An internal volume 314 extends from the upper end 308 to the lower end 310 of the backflush device 300 and is in fluid communication with the plurality of separate outlets 304. As shown in FIGS. 9 and 10, the internal volume 314 may comprise a generally cylindrical volume extending from the inlet 316 to a closed end at the lower end 310 of the backflush device 300. The backflush device comprises a plurality of baffles 318 at the periphery of the separate outlets 304 extending radially inward from the exterior surface of the backflush device and separating each of the separate outlets 304. The flow of backflush fluid can enter the internal volume 314 from the inlet 316 of the backflush device 300. The backflush fluid can flow through the internal volume 314 of the backflush device and is directed by the baffles 318 towards the plurality of outlets 304, through which the backflush fluid can flow radially outwards towards a filter element 200. In this way, the baffles 318 can be arranged to provide a more consistent flow pressure through each of the separate outlets 304 and therefore to provide more consistent flow pressure along the length of the elongate outlet 302.

FIG. 10 shows cross-sectional views along vertical planes A-A and B-B through the backflush device 300, where the planes A-A and B-B are angularly offset from each other about the longitudinal axis of the backflush device 300 (as shown in the insets in FIG. 10, which show a top-down view of the backflush device along its longitudinal axis). The backflush device 300 comprises a body 306 extending from an upper end 308 to a lower end 310 of the backflush device 300, the body having an internal volume 314 configured to receive a flow of backflush fluid from the inlet 316 at the upper end 308 of the backflush device 300. Due to the angular arrangement of the elongate outlet 302, in each of planes A-A and B-B only a portion of the elongate outlet is visible. In particular, FIG. 10 shows in each sectional view only a portion of two separate outlets 304, separated by a baffle 318. As can be seen, due to the angle of the elongate outlet 302, and the relative offset of the planes A-A and B-B, the cross-section A-A intersects the elongate outlet 302 at a lower position (e.g. closer to the lower end 310 of the device 300) than the cross-section B-B.

While the backflush device is shown in FIGS. 1 to 10 as having an elongate outlet 302 comprising a plurality of separate outlets 304. In some embodiments, the elongate outlet 302 may instead comprise a single slot arranged at an angle as described previously. Such a single slot may additionally comprise internal baffles, set back from the elongate outlet outer surface to provide consistent flow along the length of the single slot.

1. A filter system comprising a filter element and a backflush device, wherein:
the filter element comprises one or more elongate supporting portions for supporting a filtration means; and
the backflush device comprises an elongate outlet configured to provide a backflush fluid flow through the filter element such that the backflush fluid flow intersects the filter element along a line that is non-parallel with the one or more elongate supporting portions, wherein the elongate outlet comprises at least two separate outlets.

2. A filter system according to claim 1, wherein the filter element is a generally cylindrical filter element, and the backflush device is configured to provide a backflush fluid flow from the at least two separate outlets through at least a portion of the curved surface of the generally cylindrical filter element.

3. A filter system according to claim 1 or claim 2, wherein the filter element comprises a mesh upon which a filtration means may be supported.

4. A filter system according to any one of the preceding claims, wherein the filter element and the backflush device are configured to move relative to each other to provide the backflush fluid flow across a filter surface of the filter element.

5. A filter system according to any one of the preceding claims, wherein the filter element comprises a generally cylindrical filter element that is configured to rotate about its longitudinal axis to provide the backflush fluid flow across the curved surface of the filter element.

6. A filter system according to any one of the preceding claims, wherein the filter element defines an internal volume in which the backflush device is disposed, and the filter system is configured to provide filtration by passing a fluid to be filtered from an external volume surrounding the filter element through at least the portion of a filter surface of the filter element into the internal volume of the filter element.

7. A filter system according to claim 6, wherein the external volume comprises a housing surrounding the filter element and having an inlet for receiving the fluid to be filtered and an outlet for removing backflush fluid from the housing.

8. A filter system according to any one of the preceding claims, wherein the backflush device is disposed within the filter element and configured to provide the backflush fluid flow radially outwards through at least the portion of a filter surface of the filter element.

9. A filter system according to any one of the preceding claims, wherein a surface of the backflush device comprising the at least two outlets is substantially coplanar with a filter surface of the filter element.

10. A filter system according to any one of the preceding claims, wherein the spacing between the at least two outlets of the backflush device and the filter element is 15 mm or less, preferably 10 mm or less, for example 5 mm or less.

11. A filter system according to any one of the preceding claims, wherein the backflush device is configured to provide a backflush fluid flow spanning a longitudinal length of the filter element so that relative movement of the backflush device and filter element can provide the backflush fluid flow across substantially all of a filter surface of the filter element.

12. A filter system according to any one of the preceding claims, wherein the filter element is configured to support a filtration means attached and sealed around the periphery of a filter surface of the filter element to cover a filter surface of the filter element, for example wherein the filter element comprises a generally cylindrical filter element and a filtration means can be attached and sealed around the upper and lower circumferences of the filter element.

13. A filter system according to any one of the preceding claims, wherein the backflush device comprises one or more baffles arranged at the periphery of the at least two separate outlets, the baffles configured to direct a flow of backflush fluid within the backflush device towards the at least two separate outlets, for example wherein the at least two separate outlets are separated by one or more baffles that extend from an external surface comprising the at least two outlets towards an internal volume of the backflush device.

14. A filter system according to any one of the preceding claims, wherein the backflush device comprises an elongate body configured to receive a flow of backflush fluid, the at least two separate outlets configured to permit a flow of backflush fluid radially from an internal volume of the elongate body through an outward-facing surface of the elongate body, wherein the at least two separate outlets are angularly offset from each other relative to a longitudinal axis of the elongate body.

15. A filter system according to any one of the preceding claims, wherein the at least two outlets are arranged along a straight or curved line on the surface of the backflush device to provide the backflush fluid flow along the length of the straight or curved line.

16. A filter system according to any one of the preceding claims, wherein the backflush device is coupled at a central shaft within a generally cylindrical filter element and extends radially therefrom towards the curved surface of the filter element.

17. A filter system according to any one of claims 1 to 16, further comprising a filtration means integrated with or supported on the filter element.

18. A filter system comprising a filter element and a backflush device, wherein:
the filter element comprises one or more elongate supporting portions for supporting a filtration means; and
the backflush device comprises an elongate outlet configured to provide a backflush fluid flow through the filter element such that the backflush fluid flow intersects the filter element along a line that is non-parallel with the one or more elongate supporting portions, wherein the spacing between the elongate outlet of the backflush device and the filter element is 15 mm or less.

19. A filter system comprising a generally cylindrical filter element and a backflush device, wherein:
the backflush device is configured to provide a backflush fluid flow through at least a portion of the curved surface of the filter element;
the backflush device comprises an elongate outlet configured to provide the backflush fluid flow through the filter element, the elongate outlet comprising at least two portions of the outlet that are angularly offset from each other relative to the longitudinal axis of the generally cylindrical filter element; and
at least one of: (i) the elongate outlet comprises at least two separate outlets; and (ii) the spacing between the elongate outlet of the backflush device and the filter element is 15 mm or less.

20. A filter system comprising a filter element and a backflush device configured to move relative to each other to provide a backflush fluid flow across a surface of the filter element, wherein:
the backflush device comprises an elongate outlet configured to provide the backflush fluid flow through the filter element such that the backflush fluid flow intersects the filter element along a line that is non-perpendicular to the direction of relative movement of the backflush device and the filter element; and
at least one of: (i) the elongate outlet comprises at least two separate outlets; and (ii) the spacing between the elongate outlet of the backflush device and the filter element is 15 mm or less.

21. A filter system according to any one of claims 18 to 20, wherein the filter system, filter element or backflush device are as further defined in any one of claims 1 to 17.

22. A backflush device for providing a backflush fluid flow to a filter element of a filter system, the backflush device comprising:
an elongate body configured to receive a flow of backflush fluid; and
an elongate outlet configured to direct a flow of backflush fluid radially from an internal volume of the elongate body through an outward-facing surface of the elongate body;
wherein the elongate outlet comprises at least two separate outlets that are angularly offset from each other relative to a longitudinal axis of the elongate body.

23. The backflush device of claim 22, wherein the outward-facing surface comprising the elongate outlet conforms to the inner curved surface of a cylinder, the at least two separate outlets angularly offset from each other relative to the longitudinal axis of the cylinder.

24. The backflush device of claim 23, wherein the elongate outlet follows a helical path on the outward-facing surface.

25. A filter system comprising a filter element a backflush device according to any one of claims 22 to 24 arranged to provide a flow of backflush fluid through the filter element.
